(19) United States
(12) Patent Application Publication
(10) Pub. No.: US 2008/0217281 A1
(43) Pub. Date: Sep. 11, 2008

(54) Combination handbag and lunch bag with integrated lifestyle and weight loss control method

(76) Inventor: Lori Ann Moeszinger, Sunnyvale, CA (US)

Correspondence Address: LORI ANN MOESZINGER, 250 W. EL CAMINO REAL, # 1410, SUNNYVALE, CA, 94087, US

(21) Appl. No.: 11/715,147

(22) Filed: Mar. 6, 2007

(51) Int. Cl. A61J 11/00; A61J 9/00; A61J 9/08

(52) U.S. Cl. 215/11.1; 215/11.6; 215/11.4

(57) ABSTRACT

A combination handbag and lunch bag comprising: a handbag and a lunch bag each having a front, a rear, two opposing sides, a bottom, a top for joining the handbag and lunch bag portions forming a consolidated bag, a handle, a pair of holding loops or holding rings adapted for engaging the handle for drawing the handle into a continuous closed loop, a closure system enabled for snap-, clasp- or buckle-action fastening adapted for mutual engagement for drawing the combination handbag and lunch bag into a continuous closed loop for improved security and concealment of items therein, and an organizational method and program to provide an integrated closed loop planning, forecasting and control system for individuals synthesizing lifestyle, polish, and weight loss by way of integrated reference card programs, suggestions, and reminders used in combination with designated expandable pockets for predetermined organization of personal items and nutrition items therein.

### BACKGROUND OF THE INVENTION

1. Field of the Invention

The present invention relates generally to handbags and lunch bags and more particularly to a combination handbag and lunch bag with an organizational method and program to provide an integrated closed loop planning, forecasting and control system for individuals synthesizing lifestyle, polish, and weight loss. The handbag system permits daily lifestyle planning whereby an integrated reference card program for control of the individual's lifestyle and the individual's estimated personal care, polish, and well being activity routines are used in combination with designated expandable pockets for predetermined organization of personal items therein. The lunch bag system permits daily nutrition and weight loss planning whereby an integrated reference card program for control of the individual's weight and the individual's estimated food, exercise and normal activity calories is used in combination with designated expandable pockets for predetermined organization of food, beverage, and maintenance items therein. Together the systems provide the flexibility individuals need to change his or her goals, timing and adherence patterns while still maintaining control optimizing the individual's lifestyle, polish, weight loss and overall healthy living.

2. Description of Related Art

Handbags and lunch bags are well known in the art. Where handbags, purses, clutches, duffle bags, and the like have been typically used to carry personal items for users on the go, lunch bags, lunch boxes, brown bags, and the like have been typically used to carry food and beverage items for users on the go. Still, traditional handbags and lunch bags have been separate bags requiring the user to carry two bags and supply the contents therein from memory. Furthermore, in a time when a large portion of the population is becoming more and more concerned with appearances, weight, and overall health combined with living in a fast paced society with many demands on individuals' time, individuals are clamoring for efficiencies and routines that allow them lifestyle balance, polish, weight loss, and overall healthy living. Therefore, handbags and lunch bags have been produced in the prior art to enable efficiencies and organization for the user on the go. Such handbags providing pockets and dividers for organization of personal items, however, present a problem as pockets and dividers are typically not labeled, nor is there a lifestyle program and suggested content associated therein, thus it is not immediately apparent if a user is forgetting something when packing such handbags. Moreover, such lunch bags providing divider structures and containers for organization of food and beverage items, also present a problem, as they do not provide a program and suggested content associated therein for individuals desiring to lose weight. Especially for larger lunch boxes, there is a further significant problem with portion control and weight gain when packing such lunch boxes. Furthermore, although handbags have been made available with the appearance of high fashion styles and lifestyle in mind, lunch bags, as separate bags, have not. The following abstracts define the present state of this field in contending with these problems.

Lown, et al., U.S. Pat. No. D535,859 describes a lunch purse design. Hooper, U.S. Pat. No. D507,698 describes a combination lunch bag and book bag design.

Reitzel, U.S. Pat. No. 3,692,078: An accessory for personal use such as a French purse, a lady's handbag, wallet, etc., has a rigid frame formed of two U-shaped halves hinged together. The base of each half is channeled with the open side of the channels facing inwardly. Springy strips with cover material secured thereto are forcibly inserted into the channel of each base in which the strips and thus the cover material are retained by engagement of the strip ends with shoulders on the branches or legs of the frame halves.

Siegel, U.S. Pat. No. 4,250,938: A ladies handbag having a main handbag component and a separate detachable organizer clutch purse component is disclosed. The clutch purse has an organizer section for the convenient reception and display of cosmetic items and attaches to the main handbag at a hinged rear flap, or, in another embodiment, is receivable in an inner pocket of the main handbag. In one embodiment the organizer clutch is provided with expandable loops which conveniently retain cosmetic accessories in place. A viewing slot in the organizer clutch permits the user identification and access to the contained items. The organizer clutch includes a closure flap carrying a make-up mirror.

Siegel, U.S. Pat. No. 4,263,951: The disclosure relates to an organizer handbag system having multiple handbags in the system and interchangeable components and accessories. The interchangeable components and accessories may include a wallet, cosmetic case, key ring, address and note books and selected components are provided with attachment means so that the interchangeable accessories can be conveniently transferred from one handbag to another and secured therein at cooperable attachment means. Other of the accessory items are interchangeably positionable in pockets in the handbags. The accessories are selected in design and appearance to be compatible with a wide variety of handbag styles.

Bomes, et al., U.S. Pat. No. 5,105,919: A duffle bag comprised of a top wall, a bottom wall, front and back side walls, and end walls constructed to define a main storage compartment and separate end storage compartments, and at least one of the end storage compartments includes wheel assembly means for transporting the duffle bag. A further aspect of the duffle bag includes end storage compartments which are rigid and will pop open automatically when unfastened to provide a large opening to facilitate packing.

Ma, U.S. Pat. No. 6,561,240: Disclosed is an organizer for use in a handbag having one or more detachable hook and loop strips and a non-detachable, mating sheets for selectively supporting the strips within the organizer. The non-detachable, mating sheets for the dividers are at lest two lengths of hook and loop material which, having an adhesive back, are adhesively positioned adjacent each other on opposing internal walls of the purse. The hook and loop material may also be sewn into place. The hook and loop strips can be of any length preferably extending substantially from the base to the top of the purse wall. By incorporating one or more partitioning elements organizer can be divided into a plurality of compartments of varying size.

Newton, U.S. Pat. No. 6,945,293: The embodiment of this invention is disclosed, which allows a purse or handbag to be organized. The invention contemplates various sized compartments to accommodate the individual needs of a particular consumer. While the embodiments of this invention have been disclosed, certain modifications may be made, by those skilled in the art, to either the size of the organizer or the compartments in the upper section without violating the spirit of the invention.

Symonds, U.S. Pat. No. 7,004,323: A lunch box includes a housing that has top and bottom surfaces. The housing further has sidewalls integral with the bottom surface and preferably extending upwardly therefrom. Support members are secured to the plurality of sidewalls. The divider plates are removably attachable to the support members. A divider bar is slidably positionable into corresponding slots on the divider places. The divider bar also has slots formed along a length thereof. Divider members have a plurality of slots formed therein for selectively engaging the divider bar. The divider bar and the plurality of divider members advantageously cooperate with each other for maintaining food products during transportation. The lunch box further has a zipper for attaching the top surface to the housing. A flexible handle is also connected to the housing.

The prior art search with abstracts described above teaches: a lunch purse, a combination lunch bag and book bag, a lady's handbag, pouch or purse, a handbag, an interchangeable accessory system for handbags, a duffle bag, a purse organizer, another purse organizer, and a lunch box with divider structure. However, the prior art does not teach a combination handbag and lunch bag as a consolidated bag including a method providing men or women the insight into synthesizing lifestyle, polish, weight loss, and overall healthy living of the present approach so as to allow a balanced lifestyle combined with weight loss and an improved control over the process. The present invention fulfills these needs and provides further related advantages as described in the following summary.

### SUMMARY OF THE INVENTION

The present invention teaches certain benefits in construction and use which give rise to the objectives described below.

The present invention provides a specially designed combination handbag and lunch bag comprising a high fashion styled consolidated bag with an organizational method and program to provide an integrated closed loop planning, forecasting and control system for individuals synthesizing lifestyle, polish, and weight loss. The combination handbag and lunch bag is generally suited for individuals on the go, and is particularly suited for individuals desiring to balance and optimize their overall lifestyle and weight, especially for those desiring a program that includes reference card programs, suggestions and reminders used in combination with designated expandable pockets for predetermined organization of personal items and nutrition items so that such systems are automatic alleviating the individuals need to constantly remember what to pack or what to do while on the go.

The combination handbag and lunch bag comprises a handbag portion and a lunch bag portion formed from a plurality of panels, the panels stitched together forming seams between panels, the handbag and lunch bag portions each having a front, a rear, two opposing sides, a bottom and a top and having an initially open interior which is defined between the top panels and a lower peripheral edge; the top panels being permanently attached at a seam between a pair of panels used in construction of the handbag and lunch bag portions forming a consolidated bag; a pair of holding loops, rings, etc. and carrying handle being permanently attached at a seam between a pair of panels used in construction of the handbag portion; and a closure system comprising snap action fasteners, clasp fasteners, buckle fasteners, etc. being permanently attached at a seam between a pair of panels used in construction of the combination handbag and lunch bag adapted for mutual engagement for drawing the combination handbag and lunch bag into a continuous closed loop for improved security and concealment of items therein.

The combination handbag and lunch bag further comprises in combination: a handbag portion system having an integrated reference card program for control of the individual's lifestyle and the individual's estimated personal care, polish, and well being activity routines, the reference cards are located within the handbag interior for matingly engaging corresponding designated expandable pockets for predetermined organization of personal items therein; a lunch bag portion having an integrated reference card program for control of the individual's weight and the individual's estimated food, exercise and normal activity calories, the reference cards located within the lunch bag interior for matingly engaging corresponding designated expandable pockets for predetermined organization of food, beverage, and maintenance items; together the combination handbag and lunch bag systems thereby provide the flexibility individuals need to change his or her goals, timing and adherence patterns while still maintaining control optimizing the individual's lifestyle and weight.

The combination handbag and lunch bag constructions may be made from any suitable natural or synthetic material made of fabric, tanned hide, furs, etc. stitched or otherwise fastened together to form the combination handbag and lunch bag. In a preferred embodiment, the combination handbag and lunch bag contains piping, cord or string covered in material made of fabric, tanned hide, furs, etc. used for embellishment and added structure and support. Still in a preferred embodiment, the combination handbag and lunch bag contains a plurality of panels stitched at the top to form a casing for an elastic strip insert and thereafter gathered and stitched or otherwise fastened at seams between panels forming the expandable pockets therein. The means for securing the combination handbag and lunch bag together may encompass any means known in the art of securing material made of fabric, tanned hide, furs, etc. The present novel solutions are efficient, easy to use and apply, and help balance and optimize an individual's lifestyle, weight loss, and overall healthy living.

A primary objective of the present invention is to provide a combination handbag and lunch bag with an organizational method and program to provide an integrated closed loop planning, forecasting and control system for individuals synthesizing lifestyle, polish, and weight loss that yields advantages not taught by the prior art.

Another objective is to provide such an invention capable of providing the individual with a simple to use lifestyle management tool to control the individual's estimated personal care, polish, and well being activity routines more effortlessly and flexibly.

A further objective is to provide such an invention capable of providing the individual with a simple to use weight loss management tool to control weight loss more conveniently and flexibly.

A still further objective is to provide such an invention capable of providing a combination handbag and lunch bag as a consolidated bag for men or women to use to plan and forecast a balanced lifestyle, polish, and weight loss goals with convenience, direction, and ease of use.

Even still a further objective is to provide such an invention capable of providing an integrated system which is customized by the individual, consistently modeling the individual's lifestyle choices and weight loss goals daily, weekly and monthly.

Yet another objective is to provide such an invention capable of presenting this lifestyle, polish, and weight loss system as intuitive and simple, using personal care routines and diet and/or exercise, in the way most individuals are accustomed to thinking and acting when balancing an individual's lifestyle and/or losing weight.

Yet a further objective is to provide such an invention capable of permitting the individual greater flexibility to vary daily lifestyle routines and schedules, and food and exercise calories, while still remaining in control and accommodating changes easily without loss of control.

Yet still a further objective is to provide such an invention capable of allowing the use of reasonable estimates of actual lifestyle routines and schedules, and food and exercise calories, rather than exact values thereby eliminating the additional effort of collecting more exacting time and calorie data and mitigating the ever present concern over time and calorie accuracy without necessarily losing lifestyle or weight loss effectiveness.

Even yet still a further objective is to provide such an invention capable of providing the individual with effective solutions for the main reasons for not optimizing or balancing lifestyle and/or losing weight so the individual can make the proper decisions based on the right reasons.

A final objective is to provide such an invention capable of providing a closed loop system to produce more efficient and optimized plans and forecasts of lifestyle, polish, weight loss, and overall healthy living.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective front view of a first preferred embodiment of the present invention, showing a jeweled carrying handle threaded through holding loops;

FIG. 2 is a perspective side view thereof;

FIG. 3 is a perspective inside view thereof, showing a first preferred embodiment of a snap closure system;

FIGS. 4A and 4B are perspective views of the present invention, showing the combination handbag and lunch bag outer coverings;

FIG. 4C is a perspective top view thereof, showing the top panel joining the combination handbag and lunch bag portions forming a consolidated bag;

FIG. 5 is a front plan view of the present invention, showing the combination handbag and lunch bag outer covering layout;

FIG. 6 is a front plan view of the piping, a cord or string covered in material used for definition, structure and support of the present invention;

FIGS. 7A and 7B are perspective views of the present invention, showing the combination handbag and lunch bag interfacings;

FIG. 8 is a front plan view of the present invention, showing the combination handbag and lunch bag interfacing layout;

FIGS. 9A and 9B are perspective views of the present invention, showing the combination handbag and lunch bag linings and expandable pockets thereof;

FIG. 10 is a front plan view of the present invention, showing the combination handbag and lunch bag linings and expandable pockets layout;

FIGS. 11A and 11B are perspective views of the present invention, showing the reference cards in predetermined designated expandable pockets of the combination handbag and lunch bag;

FIGS. 12A, 12B and 12C are front plan views of the present invention, showing the daily lifestyle planning integrated reference card program;

FIG. 13 is a front plan view of the present invention, showing the daily polish planning integrated reference card program;

FIG. 14 is a front plan view of the present invention, showing the daily nutrition and weight loss planning integrated reference card program;

FIG. 15 is a perspective front view of a second preferred embodiment of the present invention, showing a strap encircling the combination handbag and lunch bag forming a closed loop, a clasp closure system, and a jeweled carrying handle threaded through holding rings;

FIG. 16 is a perspective side view thereof;

FIG. 17 is a perspective front view of a third preferred embodiment of the present invention, showing the lunch bag is the same length as the handbag with a strap encircling the combination handbag and lunch bag forming a closed loop, a clasp closure system, and a jeweled carrying handle threaded through holding rings;

FIG. 18 is a perspective side view thereof;

FIG. 19 is a perspective front view of a fourth preferred embodiment of the present invention, showing the handbag is the same length as the lunch bag with several straps encircling the combination handbag and lunch bag forming a closed loop, a buckle closure system, and a strap carrying handle threaded through buckles;

FIG. 20 is a perspective inside view thereof, showing a buckle closure system; and

FIG. 21 is a sectional view taken along cutting lines 21-21 in FIGS. 5, 8 and 10.

### DETAILED DESCRIPTION OF THE INVENTION

The above-described drawing figures illustrate the invention in at least one of its preferred embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

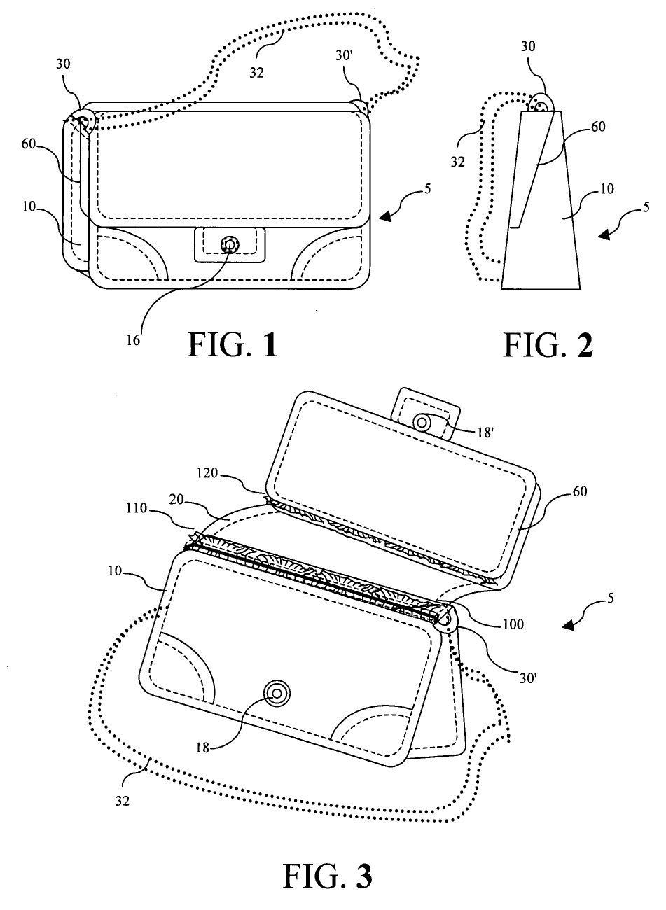

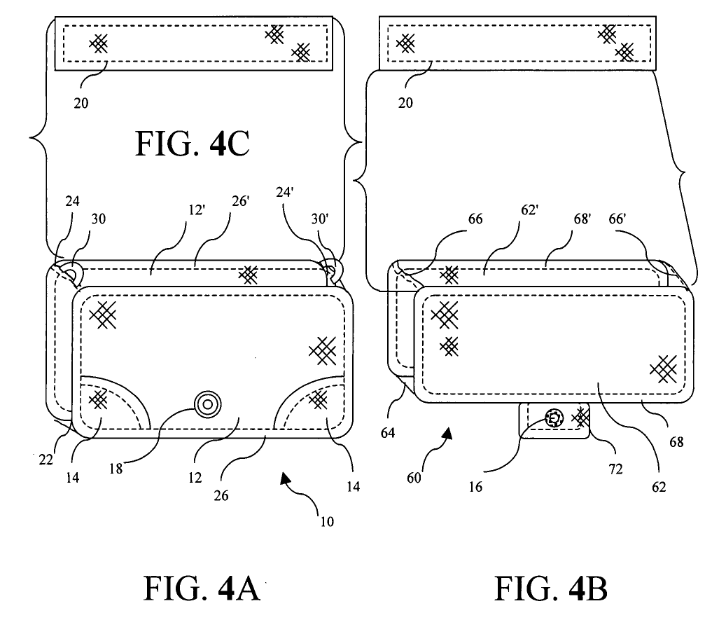

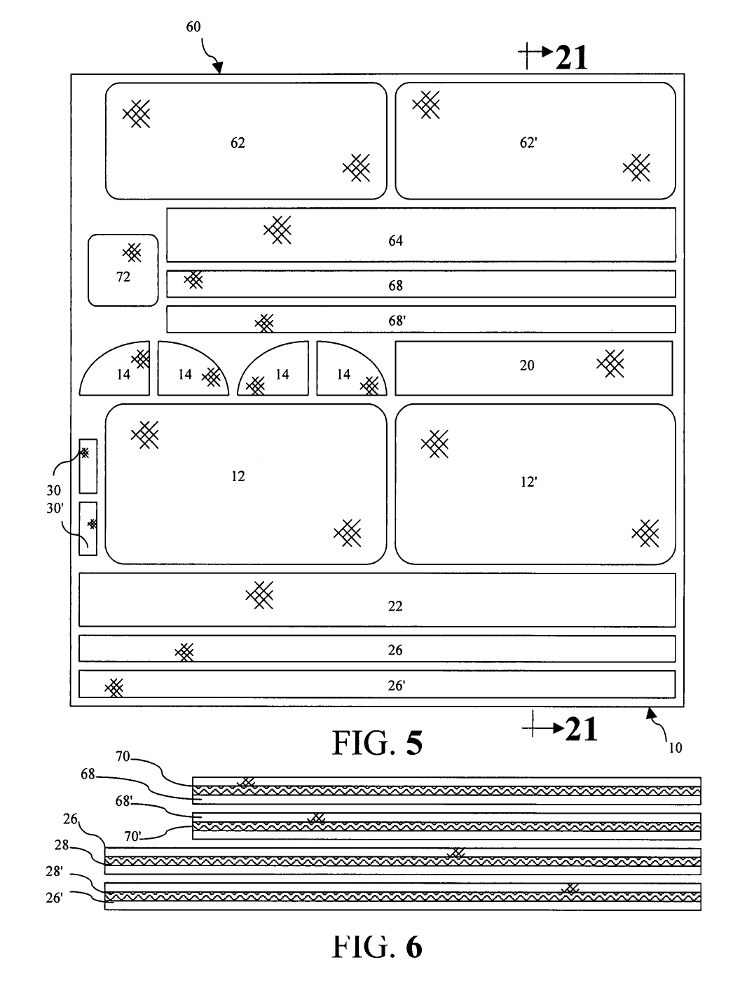

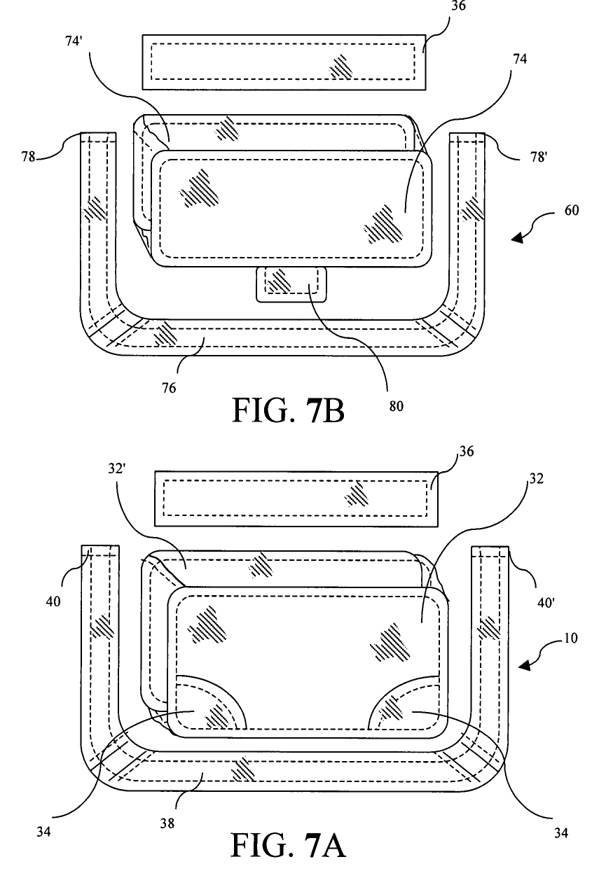

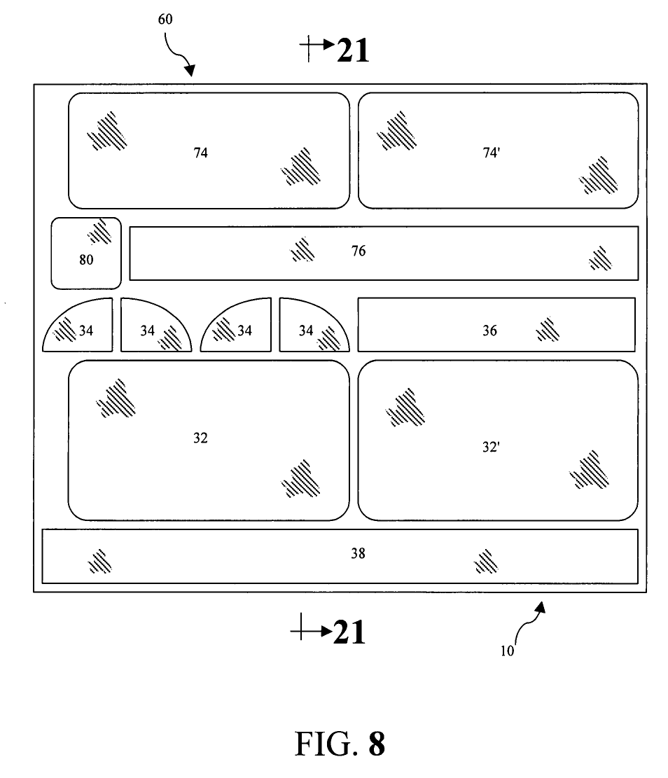

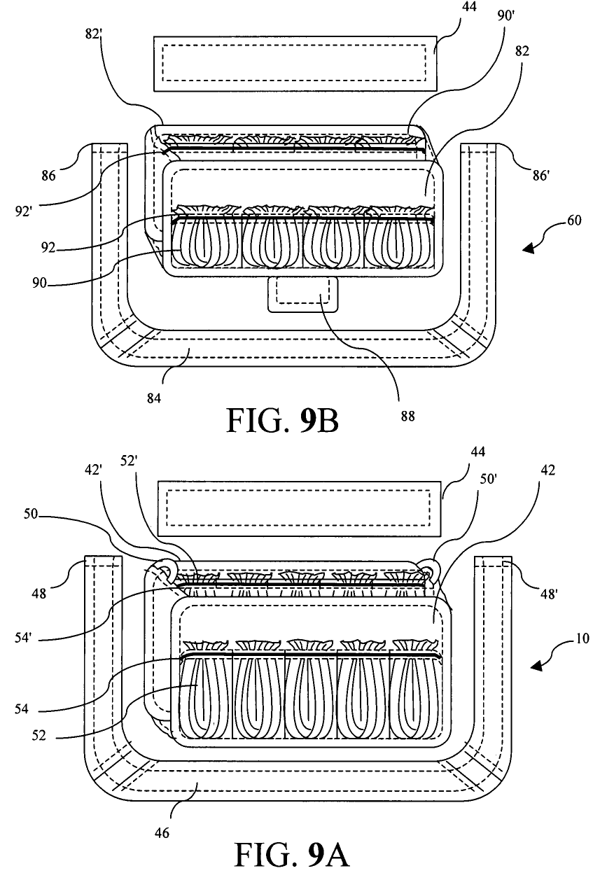

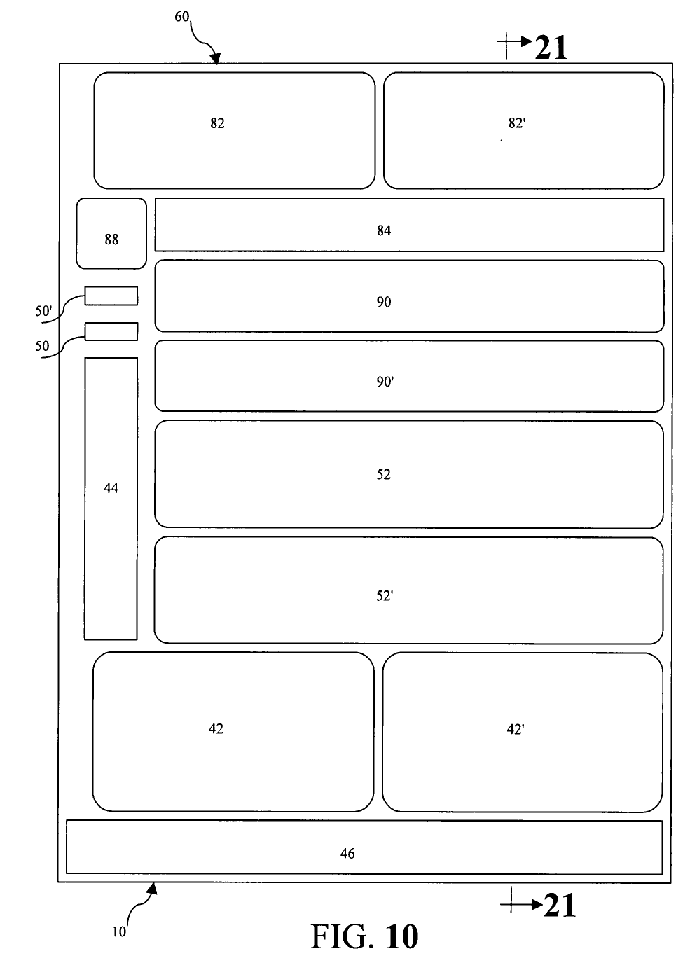

The present invention, in one embodiment, as shown in FIGS. 1, 2 and 3, is a combination handbag and lunch bag 5 including an organizational method and program to provide an integrated closed loop planning, forecasting and control system for individuals synthesizing lifestyle 100, polish 110, and weight loss 120 comprising in combination, a handbag 10 having a series of pairs of vertically spaced apart front 12, 32, 42 and rear 12′, 32′, 42′ panels, a series of pairs of horizontally spaced apart front and rear corner panels 14 and 34, a closure system 16 first fastening means 18, a series of top 20, 36, 44 panels, a series of gusset 22, 38, 46 panels forming the sides and bottom of the bag, the gusset panels each having a first end 24, 40, 48 and second end 24′, 40′, 48′, a pair of bias strip 26 and 26′ panels stitched at the top to form a casing for a cord 28 and 28′ insert to form piping for definition, structure and support. Preferably, the piping, a cord or string covered in material made of fabric, tanned hide, furs, and the like is used for embellishment and added structure and support for the handbag as shown in FIG. 6. A pair of horizontally spaced apart holding loops 30, 50 and 30′, 50′ respectively, a jeweled carrying handle 32, a pair of vertically spaced apart pocket 52 and 52′ panels stitched at the top to form a casing for an elastic strip 54 and 54′ insert and thereafter gathered and stitched or otherwise fastened at seams between panels to form the expandable pockets therein. In this embodiment, the holding loops 30, 30′ and 50, 50′ may be simple threaded loops or may be fabric loops sewn to the gusset ends 24, 40, 48 and 24′, 40′, 48′ respectively. A lunch bag 60 having a series of pairs of vertically spaced apart front 62, 74, 82 and rear 62′, 74′, 82′ panels, a closure system 16 second fastening means 18′, a series of gusset 64, 76, 84 panels forming the sides and bottom of the bag, the gusset panels each having a first end 66, 78, 86 and second end 66′, 78′, 86′, a pair of bias strip 68 and 68′ panels stitched at the top to form a casing for a cord 70 and 70′ insert to form piping for definition, structure and support (FIG. 6), a front closure 72, 80, 88 panel, a pair of vertically spaced apart pocket 90 and 90′ panels stitched at the top to form a casing for an elastic strip 92 and 92′ insert and thereafter gathered and stitched or otherwise fastened at seams between panels to form the expandable pockets therein. This relationship is best shown in FIGS. 4, 7 and 9 and again in plan view layouts FIGS. 5, 8 and 10.

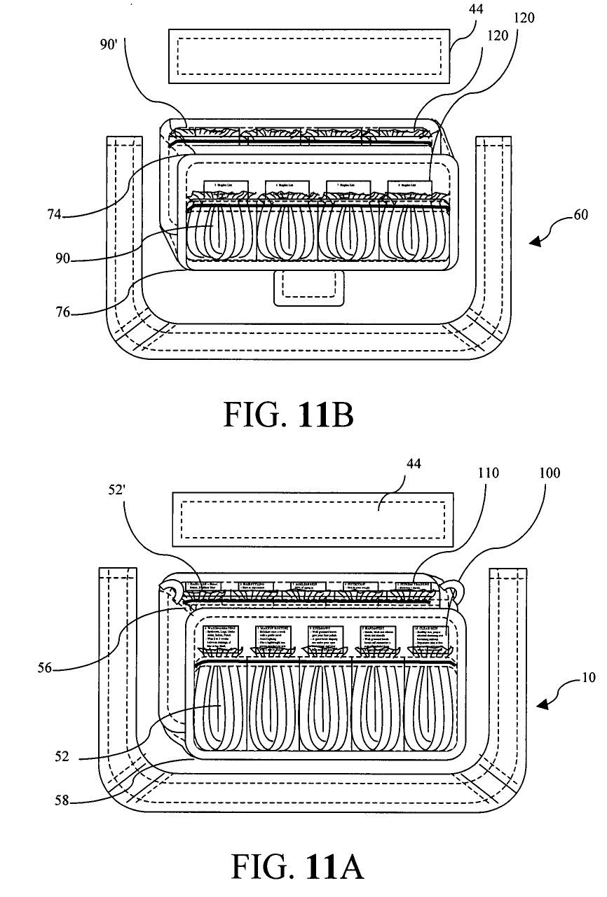

The combination handbag and lunch bag 5 further comprising in combination: a handbag 10 system comprises of an integrated reference card program for control of the individual's lifestyle 100 and the individual's estimated personal care, polish 110, and well being activity routines, the reference cards 100 and 110 are located within the handbag 10 initially open interior 56 which is defined between the top panels 20, 36, 44 and a lower peripheral edge 58 for matingly engaging corresponding designated expandable pockets 52, 52′ for predetermined organization of personal items therein. A lunch bag 60 system comprises of an integrated reference card program for control of the individual's daily nutrition and weight loss 120 planning for control of the individual's weight and the individual's estimated food, exercise and normal activity calories, the reference cards 120 are located within the lunch bag 60 initially open interior 74 which is defined between the top panels 20, 36, 44 and a lower peripheral edge 76 for matingly engaging corresponding designated expandable pockets 90, 90′ for predetermined organization of food, beverage, and maintenance items therein. The systems reference card programs 100, 110 and 120 together provide the flexibility individuals need to change his or her goals, timing and adherence patterns while still maintaining control optimizing the individual's lifestyle, polish, weight loss and healthy living. This relationship is best shown in FIGS. 11A and 11B.

Preferably, the first and second fastening means 18, 18′ of the closure system 16 are made of a snap fastener enabled for being joined by a snap action between handbag 10 and lunch bag 60. Such snap action fasteners are well known in the art, so that further discussion is not present.

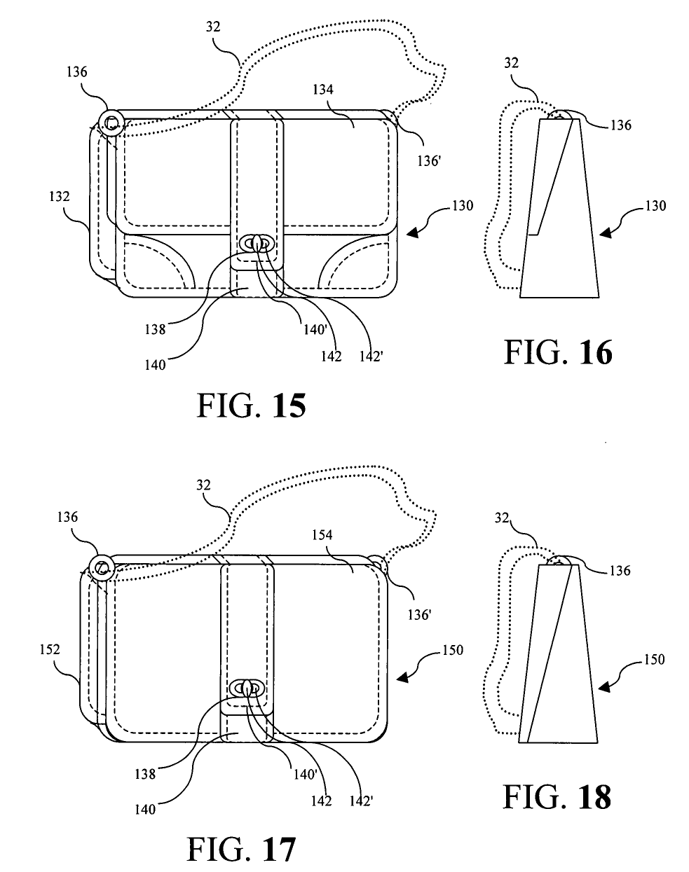

In an alternative second embodiment 130 as shown in FIGS. 15 and 16, the handbag 132 and lunch bag 134 portion holding loops 30 are replaced by holding rings 136 and 136′. The carrying handle used in this embodiment may be the same jeweled carrying handle 32 used, as described above. The closure system used in this embodiment may be the same closure system 16 used, as described above. Alternatively, a different closure system 138 may comprise an elongate body providing a pair of terminal ends 140, 140′ in mutual opposition. Each of the ends may be formed as a strap in shape as shown in FIG. 15. This closure system 138 first terminal end 140 having a clasp connector fastening means 142 and second terminal end 140′ having a clasp cooperating fastening means 142′ adapted by their conformation, for mutual engagement for drawing the combination handbag and lunch bag 130 into a continuous closed loop forming the closure system 138 for improved security and concealment of items therein. Such clasp connectors and cooperating fasteners are well known in the art, so that further discussion is not present.

In an alternative third embodiment 150 as shown in FIGS. 17 and 18, the lunch bag 152 is the same length as the handbag 154. The holding devices used in this embodiment may be the same holding loops 30 or holding rings 136, as described above. The carrying handle used in this embodiment may be the same jeweled carrying handle 32 used, as described above. The closure system used in this embodiment may be the same closure system 138 used, as described above.

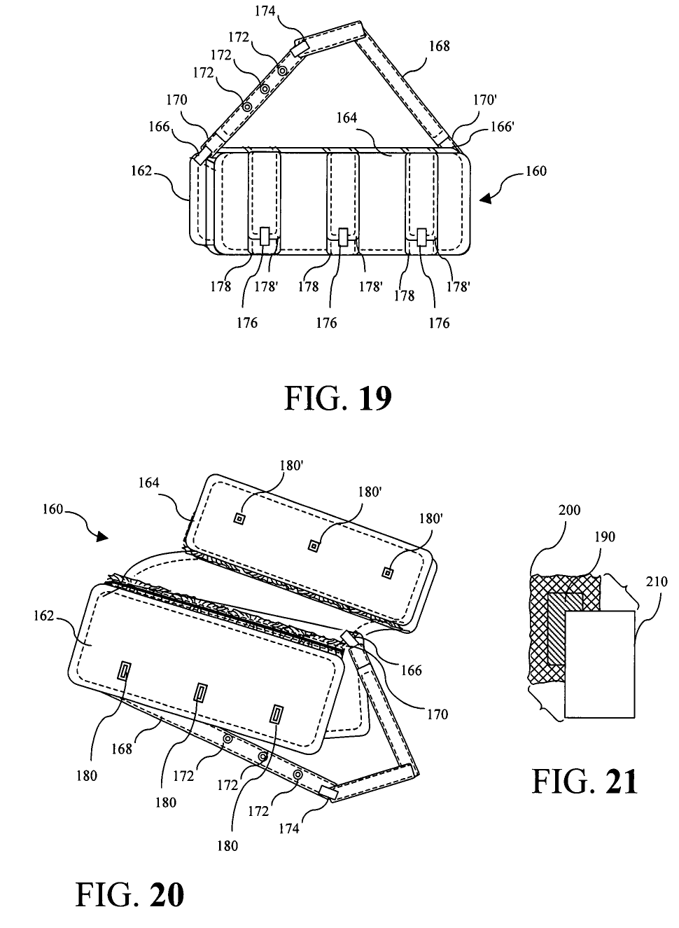

In an alternative fourth embodiment 160 as shown in FIGS. 19 and 20, the handbag 162 is the same length as the lunch bag 164. In this embodiment, the holding devices may be the same holding loops 30 or holding rings 136, as described above. Alternatively, the holding loops 30 or holding rings 136 are replaced with buckles 166 and 166′. The carrying handle used in this embodiment may be the same jeweled carrying handle 32 used, as described above. Alternatively, a different carrying handle 168 may comprise an elongate body providing a pair of terminal ends 170, 170′ in mutual opposition for engaging the holding devices 30, 136 or 166. Each of the ends may be formed as a strap 168 with apertures 172 and buckle action fastening 174 in shape for increasing or decreasing the circumference of the carrying handle 168 for adjustably lengthening or shortening the carrying handle as best shown in FIG. 19. The closure system used in this embodiment may be the same closure system 16 or 138 used, as described above. Alternatively, a different closure system 176 may comprise a series of elongated bodies providing a series of pairs of terminal ends 178, 178′ in mutual opposition. Each of the ends may be formed as a strap in shape as shown in FIG. 19. This closure system 176 first terminal ends 178 having buckle connector fastening means 180 and second terminal ends 178′ having buckle cooperating fastening means 180′ adapted by their conformation, for mutual engagement for drawing the combination handbag and lunch bag 160 into a continuous closed loop forming the closure system 176 for improved security and concealment of items therein and a more masculine look for the male user as shown in FIGS. 19 and 20. Such buckle connectors and cooperating fasteners are well known in the art, so that further discussion is not present.

In further describing the present invention it may be seen that the combination handbag and lunch bag 5, 130, 150 or 160, having a carrying handle first engagement elements; jeweled carrying handle 32, strap carrying handle 168, etc. and holding device second engagement elements holding loops 30, holding rings 136, buckles 166, etc. adapted for engaging first engagement elements for drawing the carrying handles 32, 168, etc. into a continuous closed loop for carrying the combination handbag and lunch bag 5, 130, 150 or 160. Still in further describing the present invention it may be seen that the combination handbag and lunch bag 5, 130, 150 or 160, having a closure system 16, 138, or 176 comprising a linking means portion 12, 32, 42 and 72, 80, 88, or 140 and 140′ or 178 and 178′, with opposing second engagement elements 18 and 18′, 142 and 142′ or 180 and 180′ adapted for mutual engagement for drawing the combination handbag and lunch bag 5, 130, 150 or 160 into a continuous closed loop for improved security and concealment of items therein where the linking portion comprises a stiff but flexible interfacing 190 covered by a fabric, tanned hide, fur, etc. exterior 200 and interior 210 as shown in FIG. 21.

Preferably, the combination handbag and lunch bag 5, 130, 150 or 160 may be comprised of a plurality of panels and piping forming the handbag 10, 132, 152 or 162 and lunch bag 60, 134, 154 or 164, with means to carry and secure the combination handbag and lunch bag in place. In a preferred embodiment the handbag 10 or 132 portion is the highest and widest portion when carried by the user in the upright position. The lunch bag 60 or 134 portion is shorter and narrower than the handbag permitting a gradual taper from the widest portion of the handbag to a minimal width lunch bag. Alternatively the combination handbag and lunch bag may be variously sized to fit the user or may be designed in any shape to best accommodate the needs of the user. Often such combination handbags and lunch bags 5, 130, 150 or 160 are constructed of several panels and piping sewn together to produce an approximately rectangular continuous closed loop. On the other hand, the combination handbag and lunch bag may be formed as separate bags a fraction of the size to form a cosmetic bag, jewelry bag, toothbrush bag, travel kit bag, dop bag, and the like that would fit inside the preferred embodiments of the combination handbag and lunch bag 5, 130, 150 or 160 further optimizing the individual's organization and personal care activity routines. Still on the other hand, the combination handbag and lunch bag 5, 130, 150 or 160 may be used as a combination salon bag and spa bag, or combination jetsetter bag and romance bag, and the like including an organizational method and program to provide an integrated closed loop planning, forecasting and control system for individuals synthesizing at home salon services, spa services, traveling companion supplies, personal romance activities, and the like further optimizing the individual's lifestyle choices and social life activity routines. The latter embodiments are not shown.

Preferably, the combination handbag and lunch bag 5, 130, 150 or 160 may be made from any suitable natural or synthetic material made of fabric, tanned hide, furs or blends of these or other materials stitched or otherwise fastened together to form the combination handbag and lunch bag. In a preferred embodiment, the combination handbag and lunch bag 5, 130, 150 or 160 is layered in various fabric or other materials, interfacings, and linings for added structure and support. The means for securing the combination handbag and lunch bag 5, 130, 150 or 160 together may encompass any means known in the art of securing material made of fabric, tanned hide, furs, and the like including, but not limited to, stitching, buttons and button holes, stud and snaps, clasp fasteners, hook and eye fasteners, zipper type fasteners, apertures and buckle fasteners, aperture and lace fasteners, drawstrings and hook and loop fasteners (commonly known by the Velcro® brand).

Preferably, the combination handbag and lunch bag 5, 130, 150 or 160 comprising of a plurality of panels and piping may be secured, stitched or otherwise fastened together to form the handbag 10, 132, 152 or 162 and lunch bag 60, 134, 154 or 164; the carrying handle 32 or 168 comprising of jewels strung or otherwise fastened together, combination strap made of fabric, tanned hide, furs, etc. and apertures and buckles, or the like, extending from the sides of the handbag 10, 132, 152 or 162 may be secured, stitched or otherwise fastened at a seam between a pair of holding loops 36, holding rings 136, or buckles 166 used in construction of the combination handbag and lunch bag 5, 130, 150 or 160 for carrying the combination handbag and lunch bag; and a closure system 16, 138, or 176 comprising a linking means portion 12, 32, 42 and 72, 80, 88, or 140 and 140′, or 178 and 178′, with opposing second engagement elements 18 and 18′, 142 and 142′ or 180 and 180′ adapted for engaging the first engagement elements may be secured, stitched or otherwise fastened together to form the combination handbag and lunch bag 5, 130, 150 or 160 for improved security and concealment of items therein. These and other constructional features of the present invention add further benefits in balancing and optimizing lifestyle, polish, weight loss, and overall healthy living.

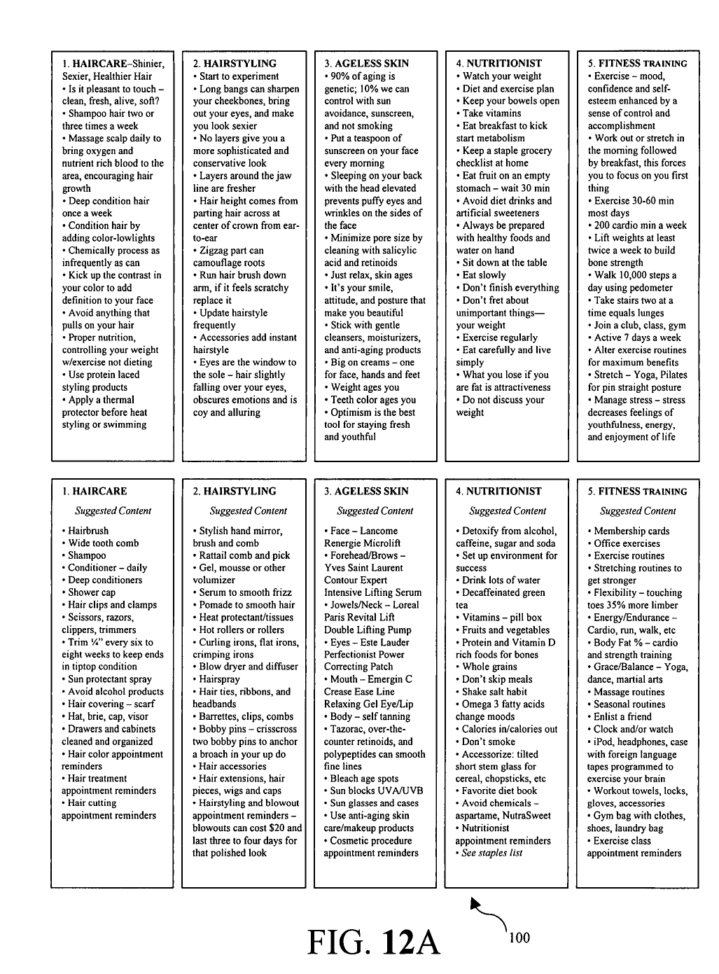

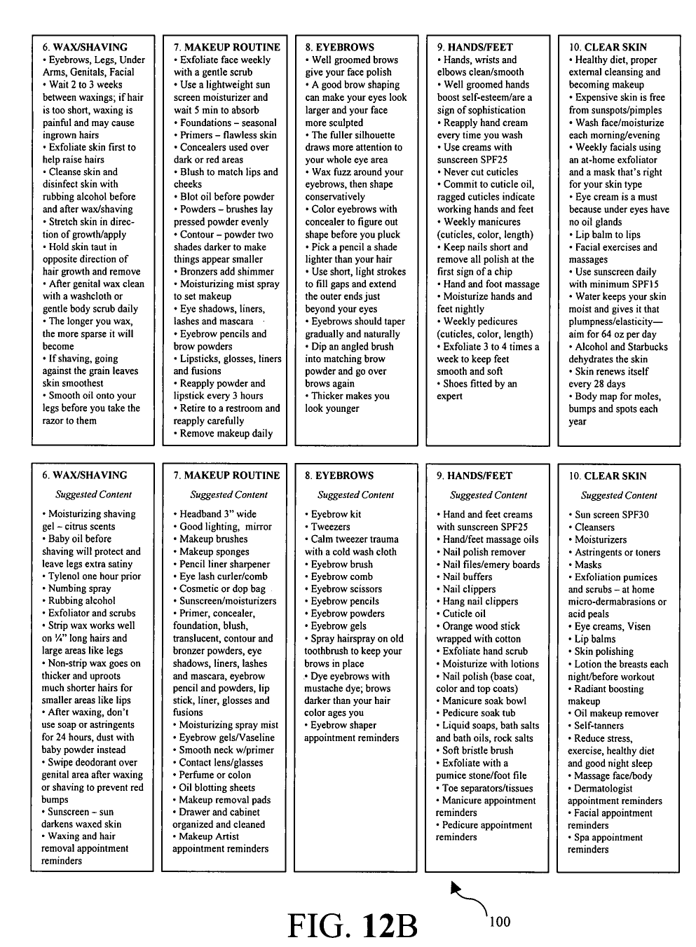

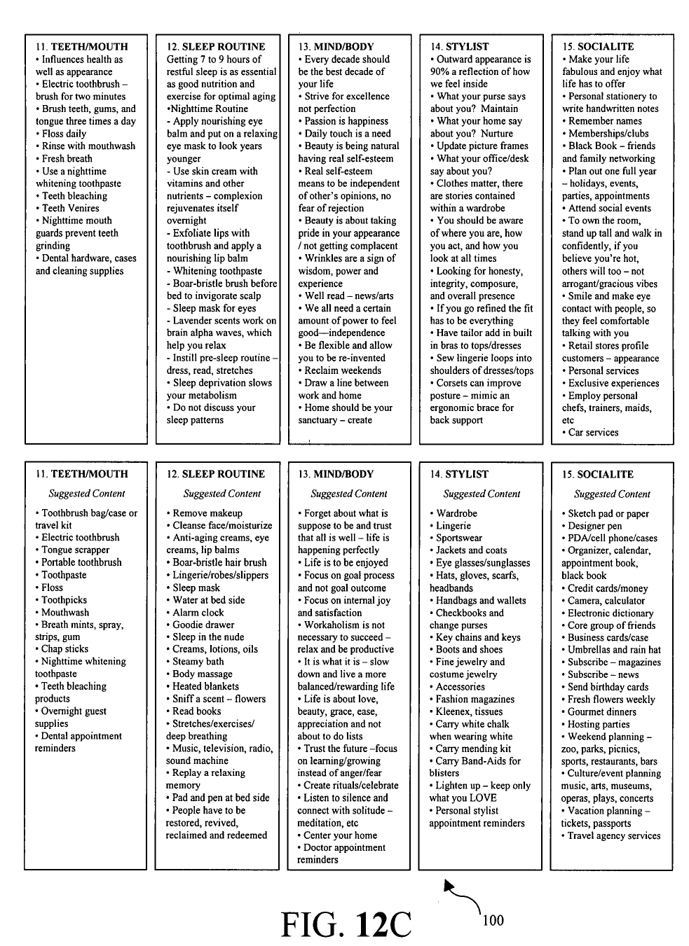

In practice and referring now to FIGS. 12A, 12B and 12C, the handbag 10, 132, 152 or 162 portion further comprises an organizational method and program providing an integrated closed loop planning, forecasting and control system which is customized by the individual, consistently modeling the individual's lifestyle choices daily, weekly and monthly having, but not limited to, the following topics: hair care, hairstyling, ageless skin, nutritionist, fitness training, waxing and shaving, makeup routine, eyebrows, hands and feet, clear skin, teeth and mouth, sleep routine, mind and body, stylist, and socialite activities and routines. The individual begins his or her lifestyle program setting up an environment for success. Thereafter the individual uses the simple to use lifestyle 100 management tool in the following manner: (a) planning daily lifestyle activities using the personal care and well being reference card programs, for calculating daily living; (b) forecasting and scheduling activities and routines into a daily tracker located in a predetermined designated handbag pocket, for measuring a balanced lifestyle; (c) supplying predetermined designated handbag pockets with personal items from the suggested content reference card lists, for daily living; (d) adjusting personal care and well being activities and routines to move toward, achieve, and maintain a planned lifestyle balance; and (e) repeating steps (a) through (d) daily until planned lifestyle is reached. Such a method and program allows the individual to take control of the individual's estimated personal care and well being activity routines more effortlessly and flexibly.

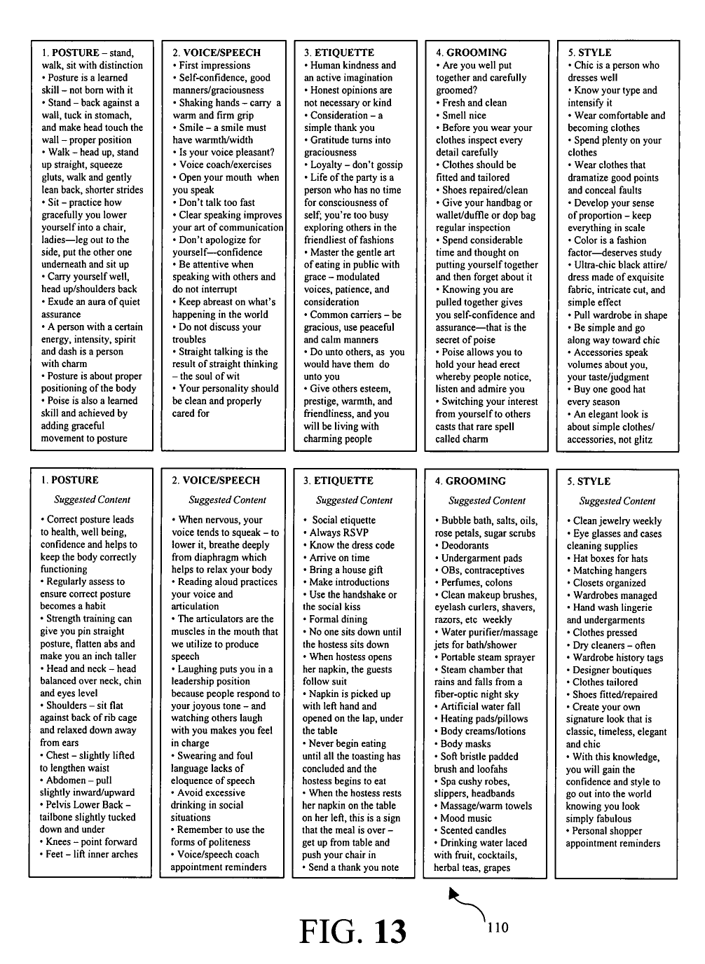

In practice and referring now to FIG. 13, the handbag 10, 132, 152 or 162 portion furthermore comprises an organizational method and program providing an integrated closed loop planning, forecasting and control system which is customized by the individual, consistently modeling the individual's image and polishing choices daily, weekly and monthly having, but not limited to, the following topics: posture, voice and speech, etiquette, grooming, and style activities and routines. The individual begins his or her image polishing program setting up an environment for success. Thereafter the individual uses the simple to use polish 110 management tool in the following manner: (a) planning daily image and polishing activities using the polishing reference card programs, for calculating daily living; (b) forecasting and scheduling activities and routines into a daily tracker located in a predetermined designated handbag pocket, for measuring image and polishing progress; (c) supplying predetermined designated handbag pockets with personal items from the suggested content reference card lists, for daily living; (d) adjusting image and polishing activities and routines to move toward, achieve, and maintain a planned self image; and (e) repeating steps (a) through (d) daily until planned self-image is reached. Such a method and program allows the individual to take control of the individual's estimated image and polishing activity routines more effortlessly and flexibly.

Preferably, the present invention lifestyle and polish management tools and methods provides the individual a predetermined program that is easily customized by the individual permitting the individual greater flexibility to vary daily lifestyle and polish schedules, activities, and routines, while still remaining in control and accommodating changes easily without loss of control. In a preferred embodiment, such a system is automatic alleviating the individual's need to constantly remember what to pack and what to do while on the go. Moreover, since outward appearance is 90% a reflection of how we feel inside such a program is desired. Whereas, nutrition, exercise, grooming and style routines to improve appearance and image without such a system are typically ad hoc at best, the present invention lifestyle and polish management tools and methods provides an intuitive and simple personal care and image polishing system the way most individuals are accustomed to thinking and acting when balancing an individual's lifestyle and optimizing an individual's self-image.

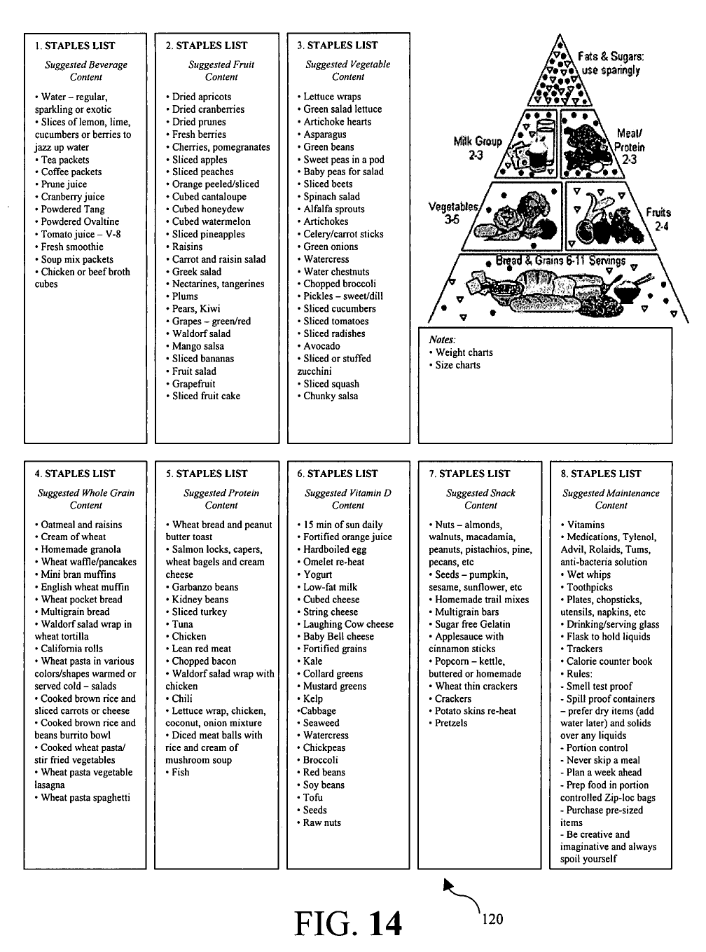

In practice and referring now to FIG. 14, the lunch bag 60, 134, 154 or 164 portion further comprises an organizational method and program providing an integrated closed loop planning, forecasting and control system which is customized by the individual, consistently modeling the individual's daily nutrition and weight loss choices daily, weekly and monthly having, but not limited to, the following topics: beverages, fruits, vegetables, whole grains, proteins, vitamin D, snacks, and maintenance activities and routines. The individual begins his or her weight loss program setting up an environment for success. Thereafter the individual uses the simple to use weight loss 120 management tool for reducing or increasing an individual's actual weight in the following manner: (a) planning daily calories expended using nutrition and fitness training reference card programs, and daily calories intake using staples suggested content reference card lists, for calculating a planned ending weight; (b) forecasting and recording date, food calories and exercise calories into a daily tracker located in a predetermined designated lunch bag pocket, for measuring a planned ending weight; (c) supplying predetermined designated lunch bag pockets with contents from staples suggested content reference card lists, for daily nutrition; (d) using the integrated reference card programs and suggested lunch bag content lists in combination with the designated lunch bag expandable pockets for predetermined organization of food, beverage, and maintenance items, which reflects the individual's compromises between goals, comfort level and lifestyle, to lose weight optimally increasing his or her success rate; (e) adjusting eating and exercise habits to move toward, achieve, and maintain a planned ending weight; and (f) repeating steps (a) through (e) daily until planned ending weight is reached. Such a method and program allows the individual to take control of the individual's weight more conveniently and flexibly.

Preferably, the present invention weight loss management tool and method provides an individual the insight and flexibility to customize their own do-it-yourself system rather than a commercial weight loss program. Likewise, 90% of individuals who lose weight use their own do-it-yourself systems rather than commercial weight loss programs. The techniques they use to lose weight are primarily diet and/or exercise. However, the principal reasons for failure are unrealistic expectations, too much effort, expense, inconvenience and requiring too much time. In a preferred embodiment, the weight loss method allows the use of reasonable estimates of actual food and exercise calories, rather than exact values thereby eliminating the additional effort of collecting more exacting time and calorie data and mitigating the ever present concern over time and calorie accuracy without necessarily losing weight loss effectiveness.

Preferably, the reference card programs 100, 110 and 120, as shown in FIGS. 12A-12C, 13 and 14 are printed on heavy weight brochure type paper. In a preferred embodiment, each card is double-sided with the “suggested content” portion on the backside of each corresponding reference card program card. Still in a preferred embodiment, each card may be laminated for added structure to prevent wear and tear of individual reference cards.

Preferably, together the systems provide the flexibility individuals need to change his or her goals, timing and adherence patterns while still maintaining control optimizing the individual's lifestyle, weight loss and overall healthy living. In a preferred embodiment, the present invention provides a closed loop system to produce more efficient and optimized plans and forecasts of lifestyle, polish, weight loss, and overall healthy living using the integrated reference card programs and suggested content lists in combination with the designated handbag and lunch bag expandable pockets for predetermined organization of personal items and nutrition items therein keeping an individual on track ensuring greater success.

The enablements described in detail above are considered novel over the prior art of record and are considered critical to the operation of the instant invention and to the achievement of the above described objectives. The words used in this specification to describe the invention and its various embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of this described invention and its various embodiments are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments below or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. In a combination handbag and lunch bag having an organizational method and program to provide an integrated closed loop planning, forecasting and control system for individuals synthesizing lifestyle, polish, and weight loss, a handbag and lunch bag system comprising in combination: a handbag having integrated reference card programs for control of the individual's lifestyle and the individual's estimated personal care, polish, and well being activity routines, said reference card programs located within the handbag interior for matingly engaging corresponding designated expandable pockets for predetermined organization of personal items therein; a lunch bag having an integrated reference card program for control of the individual's weight and the individual's estimated food, exercise and normal activity calories, said reference cards located within the lunch bag interior for matingly engaging corresponding designated expandable pockets for predetermined organization of food, beverage, and maintenance items therein; said combination handbag and lunch bag systems thereby providing flexibility individuals need to change his or her goals, timing and adherence patterns while still maintaining control optimizing the individual's lifestyle, weight loss and healthy living.

2. The invention of claim 1 wherein the method for balancing and optimizing an individual's lifestyle, the method comprising the steps of:
a) planning daily lifestyle activities using the personal care, polish, and well being reference card programs, for calculating daily living;
b) forecasting and scheduling activities and routines into a daily tracker located in a predetermined designated handbag pocket, for measuring a balanced lifestyle;
c) supplying predetermined designated handbag pockets with personal items from the suggested content reference card lists, for daily living;
d) adjusting personal care, polish, and well being activities and routines to move toward, achieve, and maintain a planned lifestyle balance; and
e) repeating steps (a) through (d) daily until planned lifestyle is reached.

3. The invention of claim 1 wherein the method for reducing or increasing an individual's actual weight, the method comprising the steps of:
a) planning daily calories expended using nutrition and fitness training reference card programs, and daily calories intake using staples list suggested content reference card lists, for calculating a planned ending weight;
b) forecasting and recording date, food calories and exercise calories into a daily tracker located in a predetermined designated lunch bag pocket, for measuring a planned ending weight;
c) supplying predetermined designated lunch bag pockets with content from staples suggested content reference card lists, for daily nutrition;
d) using the integrated reference card program and suggested lunch bag content lists in combination with the designated lunch bag expandable pockets for predetermined organization of food, beverage, and maintenance items, which reflects the individual's compromises between goals, comfort level and lifestyle, to lose weight optimally increasing his or her success rate;
e) adjusting eating and exercise habits to move toward, achieve, and maintain a planned ending weight; and
f) repeating steps (a) through (e) daily until planned ending weight is reached.

4. A handbag and lunch bag comprising in combination: an organizational method and program to provide an integrated closed loop planning, forecasting and control system for individuals synthesizing lifestyle, polish, and weight loss, a handbag and lunch bag system comprising in combination: a handbag having integrated reference card programs for control of the individual's lifestyle and the individual's estimated personal care, polish, and well being activity routines, said reference card programs located within the handbag interior for matingly engaging corresponding designated expandable pockets for predetermined organization of personal items therein; a lunch bag having an integrated reference card program for control of the individual's weight and the individual's estimated food, exercise and normal activity calories, said reference cards located within the lunch bag interior for matingly engaging corresponding designated expandable pockets for predetermined organization of food, beverage, and maintenance items therein; said combination handbag and lunch bag systems thereby providing flexibility individuals need to change his or her goals, timing and adherence patterns while still maintaining control optimizing the individual's lifestyle, weight loss and healthy living.

5. The invention of claim 4 wherein the method for balancing and optimizing an individual's lifestyle, the method comprising the steps of:
a) planning daily lifestyle activities using the personal care, polish, and well being reference card programs, for calculating daily living;
b) forecasting and scheduling activities and routines into a daily tracker located in a predetermined designated handbag pocket, for measuring a balanced lifestyle;
c) supplying predetermined designated handbag pockets with personal items from the suggested content reference card lists, for daily living;
d) adjusting personal care, polish, and well being activities and routines to move toward, achieve, and maintain a planned lifestyle balance; and
e) repeating steps (a) through (d) daily until planned lifestyle is reached.

6. The invention of claim 4 wherein the method for reducing or increasing an individual's actual weight, the method comprising the steps of:
a) planning daily calories expended using nutrition and fitness training reference card programs, and daily calories intake using staples list suggested content reference card lists, for calculating a planned ending weight;
b) forecasting and recording date, food calories and exercise calories into a daily tracker located in a predetermined designated lunch bag pocket, for measuring a planned ending weight;
c) supplying predetermined designated lunch bag pockets with content from staples suggested content reference card lists, for daily nutrition;
d) using the integrated reference card program and suggested lunch bag content lists in combination with the designated lunch bag expandable pockets for predetermined organization of food, beverage, and maintenance items, which reflects the individual's compromises between goals, comfort level and lifestyle, to lose weight optimally increasing his or her success rate;
e) adjusting eating and exercise habits to move toward, achieve, and maintain a planned ending weight; and
f) repeating steps (a) through (e) daily until planned ending weight is reached.

7. The invention of claim 4 wherein the handbag and lunch bag comprising in combination: a handbag formed from a plurality of panels, the panels stitched together forming seams between said panels, said handbag having a front, a rear, two opposing sides, a bottom and a top and having an initially open interior which is defined between the top panels and a lower peripheral edge, said opposing sides having a pair of horizontally spaced apart first engagement elements for supporting a carrying handle attached by stitching, a carrying handle second engagement element adapted for engaging first engagement elements for drawing the carrying handle into a continuous closed loop for carrying the combination handbag and lunch bag; a lunch bag formed from a plurality of panels, the panels stitched together forming seams between said panels, said lunch bag having a front, a rear, two opposing sides, a bottom and a top and having an initially open interior which is defined between the top panels and a lower peripheral edge; and a closure system comprising a linking means portion with opposing second engagement elements adapted for mutual engagement for drawing the combination handbag and lunch bag into a continuous closed loop for improved security and concealment of items therein; the linking portion comprising a stiff but flexible interfacing covered by a fabric exterior and interior.

8. The invention of claim 7 wherein the linking means comprises a stiff but flexible interfacing covered by a fabric exterior and interior and the second engagement elements are spaced-apart mutually engaging snap-fasteners.

9. The invention of claim 7 wherein the linking means comprises a stiff but flexible interfacing covered by a fabric exterior and interior and the second engagement elements are clasp-fasteners.

10. The invention of claim 7 wherein the linking means comprises a stiff but flexible interfacing covered by a fabric exterior and interior and the second engagement elements are spaced-apart apertures and spaced-apart mutually engaging buckle-fasteners.

11. The invention of claim 7 wherein the combination handbag and lunch bag further comprises boning, piping, interfacings, linings or blends of these or other materials stitched or otherwise fastened together to form the combination handbag and lunch bag for improved structure and support.

12. The invention of claim 7 wherein the combination handbag and lunch bag further comprises each having a pair of vertically spaced apart pocket panels stitched at the top to form a casing for an elastic strip insert and thereafter gathered and stitched or otherwise fastened at seams between panels to form the expandable pockets therein.

13. A handbag and lunch bag comprising in combination: a handbag having a series of pairs of vertically spaced apart front and rear panels, a series of pairs of horizontally spaced apart front and rear corner panels, a series of top panels, a series of gusset panels forming the sides and bottom of the handbag, said gusset panels each having a first end and a second end and a pair of horizontally spaced apart first engagement elements for supporting a carrying handle attached by stitching, a carrying handle second engagement elements adapted for engaging first engagement elements for drawing the carrying handle into a continuous closed loop for carrying the combination handbag and lunch bag, said handbag having an initially open interior which is defined between the top panels and a lower peripheral edge; a lunch bag having a series of pairs of vertically spaced apart front and rear panels, a series of gusset panels forming the sides and bottom of the lunch bag, a front closure panel and an initially open interior which is defined between the top panels and a lower peripheral edge; and a closure system comprising a linking means portion with opposing second engagement elements adapted for mutual engagement for drawing the combination handbag and lunch bag into a continuous closed loop for improved security and concealment of items therein; the linking portion comprising a stiff but flexible interfacing covered by a fabric exterior and interior.

14. The invention of claim 13 wherein the method for balancing and optimizing an individual's lifestyle, the method comprising the steps of:
a) planning daily lifestyle activities using the personal care, polish, and well being reference card programs, for calculating daily living;
b) forecasting and scheduling activities and routines into a daily tracker located in a predetermined designated handbag pocket, for measuring a balanced lifestyle;
c) supplying predetermined designated handbag pockets with personal items from the suggested content reference card lists, for daily living;
d) adjusting personal care, polish, and well being activities and routines to move toward, achieve, and maintain a planned lifestyle balance; and
e) repeating steps (a) through (d) daily until planned lifestyle is reached.

15. The invention of claim 13 wherein the method for reducing or increasing an individual's actual weight, the method comprising the steps of:
a) planning daily calories expended using nutrition and fitness training reference card programs, and daily calories intake using staples list suggested content reference card lists, for calculating a planned ending weight;
b) forecasting and recording date, food calories and exercise calories into a daily tracker located in a predetermined designated lunch bag pocket, for measuring a planned ending weight;
c) supplying predetermined designated lunch bag pockets with content from staples suggested content reference card lists, for daily nutrition;
d) using the integrated reference card program and suggested lunch bag content lists in combination with the designated lunch bag expandable pockets for predetermined organization of food, beverage, and maintenance items, which reflects the individual's compromises between goals, comfort level and lifestyle, to lose weight optimally increasing his or her success rate;
e) adjusting eating and exercise habits to move toward, achieve, and maintain a planned ending weight; and
f) repeating steps (a) through (e) daily until planned ending weight is reached.

16. The invention of claim 13 wherein the linking means comprises a stiff but flexible interfacing covered by a fabric exterior and interior and the second engagement elements are spaced-apart mutually engaging snap-fasteners.

17. The invention of claim 13 wherein the linking means comprises a stiff but flexible interfacing covered by a fabric exterior and interior and the second engagement elements are spaced-apart mutually engaging clasp-fasteners.

18. The invention of claim 13 wherein the linking means comprises a stiff but flexible interfacing covered by a fabric exterior and interior and the second engagement elements are spaced-apart apertures and spaced-apart mutually engaging buckle-fasteners.

19. The invention of claim 13 wherein the combination handbag and lunch bag further comprises boning, piping, interfacings, linings or blends of these or other materials stitched or otherwise fastened together to form the combination handbag and lunch bag for improved structure and support.

20. The invention of claim 13 wherein the combination handbag and lunch bag further comprises each having a pair of vertically spaced apart pocket panels stitched at the top to form a casing for an elastic strip insert and thereafter gathered and stitched or otherwise fastened at seams between panels to form the expandable pockets therein.

21. The invention of claim 13 wherein the combination handbag and lunch bag is constructed of material made of fabric, tanned hide, furs, and the like for embellishment and added structure and support.

22. The invention of claim 13 wherein the handbag includes means for securing the handbag to the lunch bag.

23. The invention of claim 13 wherein the handbag includes means for securing the carrying handle to the handbag.
